(19) United States
(12) Patent Application Publication
(10) Pub. No.: US 2021/0140696 A1
(43) Pub. Date: May 13, 2021

(54) Ice Clamping Device

(71) Applicant: Andrew Jason Dany, Mahwah Rd, NJ (US)

(72) Inventor: Andrew Jason Dany, Mahwah Rd, NJ (US)

(21) Appl. No.: 16/679,218

(22) Filed: Nov. 10, 2019

(51) Int. Cl. F25C 5/00; B08B 7/00

(52) U.S. Cl. CPC F25C 5/00; B08B 7/0092

(57) ABSTRACT

With the components assembled and the ice block formed, the Ice clamping device will allow the user a safe and effective way use the ice block to clean a food grade grilling surface. Thereby cleaning the grilling surface without direct metal on metal contact with that surface there by eliminating the issues and hazards assorted with those cleaning tools i.e. metal from wire bristles or broken material that can be ingested.

### CROSS-REFERENCE

Not Applicable

### FEDERALLY SPONSORED RESEARCH

Not Applicable

### REFERENCE TO SEQUENCE OR PROGRAM

Not Applicable

### BACKGROUND

To clean a food grade grilling surface without direct metal on metal contact with that surface there-by eliminating the issues and hazards that are inherent in using those cleaning tools i.e. metal from wire bristles or broken material that can be ingested.

To secure a block of ice in a holder and handle which then gives the ability to use the ice as a cleaning agent in a safe and efficient way.

### BRIEF SUMMARY OF THE INVENTION

The spring loaded clamping device is the method by which a block of ice is held in place at the end of the long handle. This device allows the ice to be held tightly at the end of the handle and used as a cleaning agent on a hot surface, allowing it to clean that surface. The handle will also keep the user at a safe distance away from the heat source during the cleaning process.

### BRIEF DESCRIPTION OF THE DRAWINGS

A description of the ice clamping device drawing notes by reference numbers are:
1/2 Shows a freezer safe container which will be filled with water
1 Freezer safe container
2/2 Shows complete assembly of the ice clamping device
2 Main Handle
3 Front Scraper Plate
4 Screw Pan Head
5 Rear Spring Plate
6 Pivot Point
7 Pivot Screw
8 Compression Spring
9 Releasing Lever

### DETAILED DESCRIPTION OF THE INVENTION

1/2 Shows:

(1) A freezer safe container that will make a block of ice that is the correct size to fit between the front scraper plate and the rear spring plate. This Container will be filled with water and frozen be means of lowering the temperature below 32 degrees. When ready for use the ice block will be removed from the container and installed between the front scraper plate and the rear spring plate.

2/2 Shows:

(2) Main handle is made from a hard durable plastic formed in the injection molding process. Where molten plastic is forced into a mold containing the handle size and dimension, and then allowed to cool. It will then be removed from the mold and the process can start again. This handle is the platform where all the other parts are connected to. During use it will keep the user away from the heat source during the cleaning process.

(3) Front Scraper Plate to be made of a non-corrosive material such as stainless steel or other coating that is able to with-stand high temperatures, the outdoor elements and is food grade safe. It will be formed in a stamping process to make the size and shape needed. It will then be bent with a metal press to the correct shape to allow it to secure the ice block on one end and provide a scraper on the other end.

(4) Screw pan head made from corrosion resent material used to secure the front scraper plate to the handle.

(5) Rear spring plate to be made of a non-corrosive material such as stainless steel or other coating that is able to with-stand high temperatures, the outdoor elements and is food grade safe. It will be formed in a stamping process to make the size and shape needed, and then be formed in a bending process to the correct shape where it will secure the ice block against the front scraper plate.

(6) Pivot Point is the location where the rear spring plate is attached. This point will be located on the main handle providing the hinge for the rear spring plate to move up and down allowing opening and then closing to securing the block of ice between the rear spring plate and the front scraper plate.

(7) Pivot screw made from corrosion resent material used to hold the rear spring plate to the handle and allow it to pivot.

(6) Compression spring to be made from corrosion resent material providing the locking force needed to hold the ice in place during the cleaning process.

(7) Release Lever made from a hard durable plastic with internal threads which will allow it to be secured to the rear spring leaver. This will proving a leverage point allowing the user to compress the spring, opening the rear locking plate providing the room needed to install or remove the block of ice.

With the components listed above and assembled as depicted on FIG. 1B the device will allow the user the ability to safely and securely hold a pre-formed block of ice between the Front Scraper Plate and the Rear Spring Plate. Once this pre-formed block of ice is securely held at the end of the handle it allows the user to effectively clean a hot grilling surface by rubbing the ice along the hot surface. This action melts the ice producing steam and water. This melting action cleans the surface without any metal on metal contact thereby eliminating the potential hazards assorted with those types of cleaning tools.

What is claimed is:

1. The ability to securely and safely hold a preformed block of ice at the end of the handle allowing the user to effectively clean a hot grilling surface.
